(19) United States
(12) Patent Application Publication
(10) Pub. No.: US 2010/0039359 A1
(43) Pub. Date: Feb. 18, 2010

(54) Adjustment circuit for color sequential liquid crystal display and adjustment method thereof

(76) Inventors: Chih-Yu LIN, Tanzih Township (TW); Kai-Yi Wu, Taipei City (TW)

Correspondence Address: SINORICA, LLC, 2275 Research Blvd., Suite 500, ROCKVILLE, MD, 20850, US

(21) Appl. No.: 12/252,636

(22) Filed: Oct. 16, 2008

(30) Foreign Application Priority Data
Aug. 13, 2008 (TW) 097130865

(51) Int. Cl. G09G 3/36

(52) U.S. Cl. 345/88

(57) ABSTRACT

An adjustment circuit for color sequential liquid crystal displays and an adjustment method thereof applied to a color sequential liquid crystal display are disclosed. The color sequential liquid crystal display receives a plurality of driving signals from a light-source driving circuit to generate a plurality of primary color backlights and at least one adjusted-color backlight and also receives one display driving signal. The adjusted-color backlight is generated behind one of three primary color backlights. By means of the adjusted-color backlight, the color and brightness of the frame are adjusted.

### BACKGROUND OF THE INVENTION

1. Field of Invention

The present invention relates to an adjustment circuit and an adjustment method thereof, especially to an adjustment circuit for color sequential liquid crystal displays and an adjustment method thereof.

2. Description of Related Art

Nowadays due to advanced technology, various new information products are developed and promoted to meet people's requirements. The conventional display device has shortages of large volume, high power consumption and high radiation dose while the liquid crystal display (LCD) features on compact volume, light weight, low radiation dose and low power consumption. Thus the conventional display device is replaced by the LCD which has become a main stream of a current display market. In order to make the crystal liquid displays really have features above mentioned, a high performance light-source is required to LCD design. The LCD itself can't emit light, so that when the device is under insufficient lighting environment, a light-source is required. For example, LCD on watches uses a mini-lamp as a light-source. Car meters or office automation terminals requires a light-source on the back so that the displayed images get more vivid. These laminar light-sources used on the rear side of the LCDs are called back lights.

Conventional LCD uses color filters to filter light so as to show the color of a pixel formed by three primary colors. To create a color image, there are three subpixels in each pixel-red, green and blue, respectively corresponding to red, green and blue color filters. Due to persistence of vision, the human eye receives red, green and blue light through the color filters and perceives pixel color. The light transmission of the LCD display and single pixel (dot) size are limited by the color filter. Thus display quality of the LCD is affected by the color filter.

In order to solve the above mentioned problem, a color sequential LCD has been developed. In the color sequential display, three primary colors of each pixel are displayed sequentially. A frame is decomposed into red, green, and blue fields displayed in successively. The three fields are illuminated by the red, green, and blue backlight accordingly. Relying on the human vision system, the successive images are fused into a color image. Thus the sequential display includes no color filter. Moreover, in contrast to pixel size of the LCD with color filter, the pixel size of the sequential display is smaller. Therefore, the color sequential display has higher resolution with lower cost.

A conventional color sequential CLD only uses lighting units such as light emitting diode with three primary colors-red(R), green(G) and blue(B) as backlights. Lights from the three primary color (RGB, tricolor) backlights are mixed to form a color of a single pixel. The mixing of three primary colors only generates eight basic colors so that each pixel has eight possible colors. Thus the use of the colors on the conventional color sequential LCD is quite monotonous. Moreover, when images are shown on a conventional sequential LCD by color sequential operation, the brightness is insufficient. Thus the quality of color images displayed on the color sequential LCD is reduced.

Therefore, there is a need to provide an adjustment circuit for color sequential liquid crystal displays and an adjustment method thereof that overcome the shortcoming of monotonous colors of conventional color sequential LCD and solve the problems mentioned above.

### SUMMARY OF THE INVENTION

It is therefore a primary object of the present invention to provide an adjustment circuit for color sequential liquid crystal displays and a method thereof. The colors displayed by the color sequential LCD are adjusted according to at least one adjusted-color backlight generated behind the tricolor backlights. Thus overall number of colors that can be rendered is increased and the display brightness is also improved.

In order to the achieve object, the present invention provides an adjustment circuit for color sequential liquid crystal displays and an adjustment method thereof. The adjustment circuit includes a light-source driving circuit and a display driver circuit. The light-source driving circuit generates a plurality of driving signals and the display driver generates a display driving signal. The driving signals are used to control the color sequential LCD for generating a plurality of three primary color (RGB, tricolor) backlights and at least one adjusted-color backlight. According to the display driving signal, the tricolor backlights and the adjusted-color backlight, the color sequential LCD displays a frame. The method of the present invention adjusts colors by the adjusted-color backlight for further adjustment of colors and brightness of the frames. The adjusted-color backlight is generated behind one of the tricolor backlight. Moreover, according to colors of each frame, the light-source driving circuit adjusts time of the color sequential LCD to generate the adjusted-color backlight for adjusting colors displayed by the frame so as to further improve color quality of displayed images.

### BRIEF DESCRIPTION OF THE DRAWINGS

The structure and the technical means adopted by the present invention to achieve the above and other objects can be best understood by referring to the following detailed descriptions of the preferred embodiments and the accompanying drawings, wherein

FIG. 1 is a block diagram of an embodiment according to the present invention;

FIG. 2A is a schematic diagram of a pixel of an embodiment according to the present invention;

FIG. 2B is a timing diagram of an embodiment according to the present invention;

FIG. 3A is a schematic diagram of a pixel of another embodiment according to the present invention;

FIG. 3B is a timing diagram of another embodiment according to the present invention.

### DETAILED DESCRIPTION OF THE PREFERRED EMBODIMENT

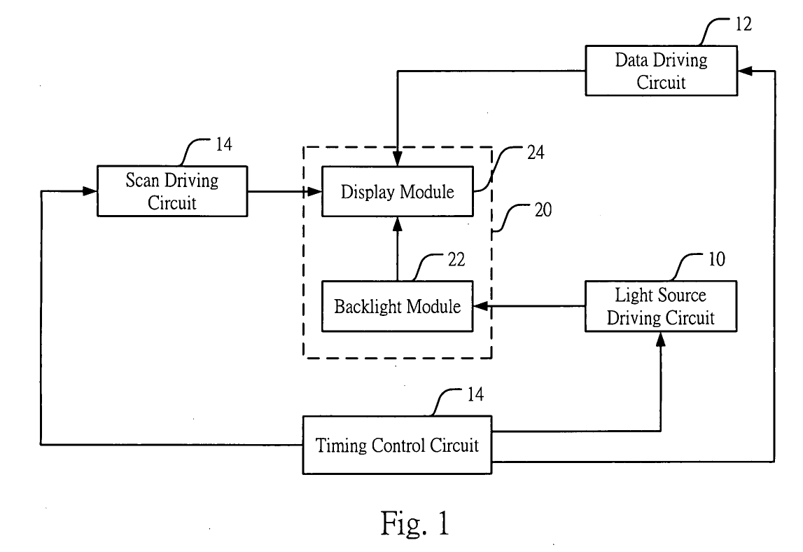

Refer to FIG. 1, a block diagram of an embodiment of the present invention is revealed. The embodiment is applied to a Twisted Nematic LCD (TN LCD), a Super Twisted Nematic LCD (STN LCD), or other LCDs such as Thin-Film Transistor LCD (TFT LCD). As shown in figure, an adjustment circuit of the present invention includes a light-source driving circuit 10, and a display driving circuit having a data driving circuit 12 and a scan driving circuit 14. The color sequential LCD includes a display panel 20 formed by a backlight unit 22 and a display module 24. The light-source driving circuit 10 generates a plurality of driving signals and sends the driving signals to the backlight unit 22 of the display panel 20 so as to control the backlight unit 22 generating a plurality of three primary color (RGB, tricolor) backlights sequentially and at least one adjusted-color backlight. The tricolor backlight includes red backlight, green backlight and blue backlight. An embodiment of the adjusted-color backlight is white backlight. The adjusted-color backlight can be formed by mixing of tricolor backlight, but not limited to. Or it can be also formed by a single light-source such as white-light LED.

The display driving circuit is for generating a display driving signal which includes a data signal and a scan signal. The data driving circuit 12 of the display driving circuit is for generating the data signal and sending the data signal to the display module 24 of the display panel 20. The data signal includes a plurality of data pulses. The scan driving circuit 14 of the display driving circuit is used to generate the scan signal and send the scan signal to the display module 24 of the display panel 20.

Based on the above description, according to the display driving signal, and in combination with sequential tricolor (RGB) backlights as well as mixing-color backlight generated by the backlight unit 22, the display panel 20 of the color sequential LCD displays a frame. Moreover, the light-source driving circuit 10 of the present invention can adjust time of the backlight unit 22 to generate adjusted-color backlight according to colors of different frames so as to modify colors shown by the display module 24.

Refer back to FIG. 1, the adjustment circuit for color sequential LCD according to the present invention further includes a timing control circuit 16 that generates a timing signal according to images intend to be displayed on the color sequential LCD and sends the timing signal to the light-source driving circuit 10, the data driving circuit 12 and the scan driving circuit 14 of the display driver circuit. After receiving the timing signal, the light-source driving circuit 10, the data driving circuit 12 and the scan driving circuit 14 respectively generate the driving signals, the data signal and the scan signal for driving the display panel 20 to show the frame. Moreover, the timing control circuit 16, the data driving circuit 12 and the scan driving circuit 14 can be integrated into a control IC (integrated circuit) so as to reduce the area occupied by the adjustment circuit for saving cost. Furthermore, the light-source driving circuit 10 is also integrated into the control IC.

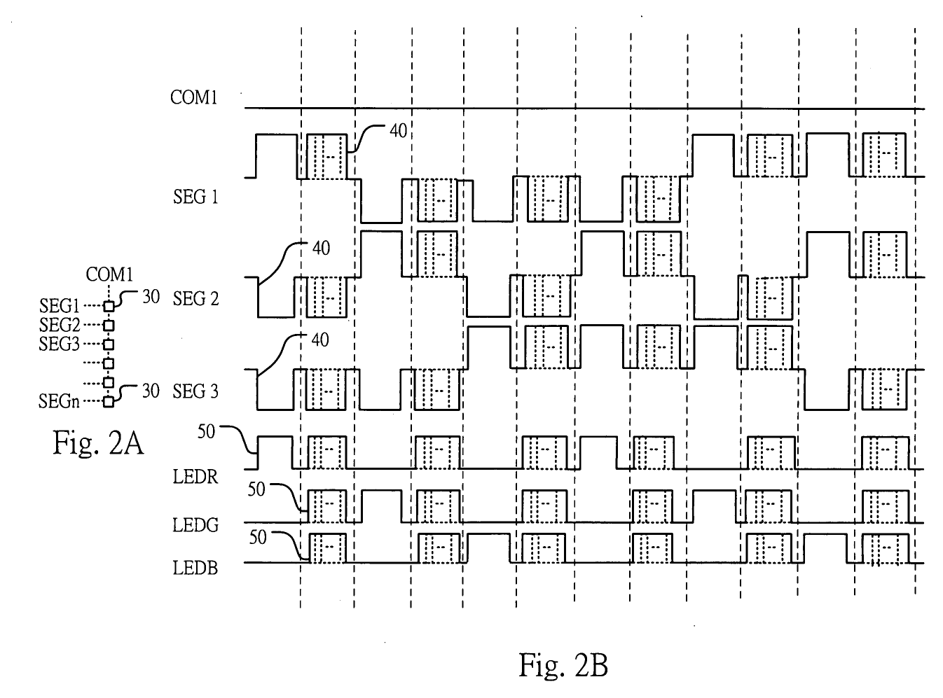

Refer to FIG. 2A & FIG. 2B, a schematic diagram of a pixel and a timing diagram of an embodiment are revealed. A color mixing method of the present invention is described in the following description. As shown in figure, COM1 is a scan signal from the scan driving circuit 14 while SEG1, SEG2, SEG3 respectively are a first data signal, a second data signal and a third data signal generated by the data driving circuit 12. According to the scan signal COM1 and data signals SEG1, SEG2, SEG3, the display module 24 controls a corresponding pixel 30. The scan signal COM1 is a direct current signal maintained at a substantially constant level without level change. The data signals SEG1, SEG2, SEG3 respectively include a plurality of data pulses 40. In accordance with level changes of these data pulses 40, the display module 24 controls rotation angle of liquid crystals corresponding to the corresponding pixel 30.

As to LEDR, it's a driving signal from the light-source driving circuit 10 to drive the backlight unit 22 generating the red backlight. LEDG represents a driving signal from the light-source driving circuit 10 to drive the backlight unit 22 generating the green backlight and LEDB is a driving signal from the light-source driving circuit 10 to drive the backlight unit 22 generating the blue backlight. These driving signals include a plurality of driving pulses 50. When these driving pulses 50 of driving signals LEDR, LEDG, LEDB are at high level, this means that the backlight unit 22 generates backlights of three primary colors (RGB, tricolor)—red backlight, green backlight and blue backlight. In this embodiment, the adjusted-color backlight is a white backlight that is generated behind each backlight. Thus when driving signals for tricolor backlight LEDR, LEDG, and LEDB are all at high level, the light-source driving circuit 10 uses this as a driving signal corresponding to generation of the adjusted-color backlight. Therefore, by increasing of the adjusted-color backlight behind each backlight, the present invention adjusts gray level of tricolor backlights so as to increase number of colors rendered and enhance display brightness on the display module 24.

Moreover, according to colors of the frame, the light-source driving circuit 10 adjusts pulse width of driving pulses of the driving signals corresponding to the adjusted-color backlights so as to modify gray level of colors. For example, the pulse width of the driving signal corresponding to the adjusted-color backlight is divided into eight equal parts so that the light-source driving circuit 10 adjusts pulse width of the driving pulses 50 of the driving signals LEDR, LEDG, and LEDB into 8 different widths. Thus the mixed color backlight has 8 different gray level patterns. The combinations of red backlight and white backlight include R+0/8 W, R+1/8W, R+2/8W, R+3/8W, R+4/8W, R+5/8W, R+6/8W, R+7/8W, and R+8/8W. The combinations of green backlight and white backlight include G+0/8 W, G+1/8W, G+2/8W, G+3/8W, G+4/8W, G|5/8W, G|6/8W, G|7/8W, and G|8/8W. The combinations of blue backlight and white backlight include B+0/8 W, B+1/8W, B+2/8W, B+3/8W, B+4/8W, B+5/8W, B+6/8W, B+7/8W, and B+8/8W.

According to the above description, the present invention dramatically increases number of colors of the pixel 30 by adjustment of gray levels of the adjusted-color backlight. Due to nine color patterns of each tricolor backlight, there are 729 (9×9×9) colors represented by the pixel 30. Thus there are quite a lot colors available per each pixel and this is significantly better than conventional color sequential LCD.

Furthermore, when the light-source driving circuit 10 adjusts the pulse width of the driving pulses 50 of the driving signals LEDR, LEDG, and LEDB for adjusting generation time of the adjusted-color backlight, the data driving circuit 12 correspondingly adjusts the pulse width of data pulses 40 of the data signals SEG1, SEG2, SEG3 in accordance with the generation time of the adjusted-color backlight.

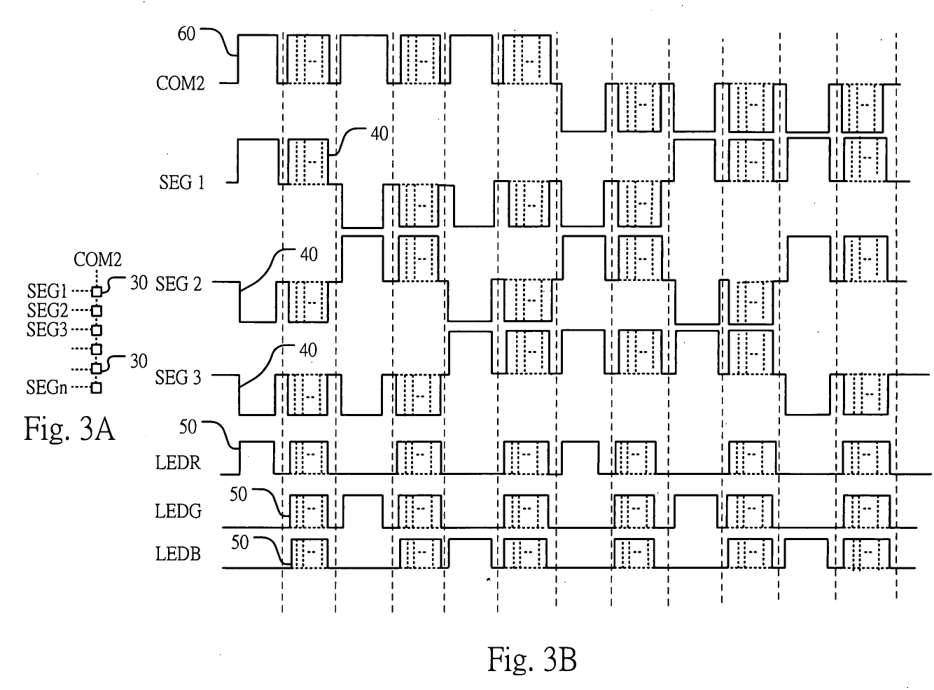

Refer to FIG. 3A & FIG. 3B, a schematic diagram of a pixel and a timing diagram of another embodiment are revealed. The difference between the embodiment in FIG. 2B and the one in FIG. 3B is in that the scan signal COM1 in FIG. 2B is at constant level while the scan signal COM2 in FIG. 3B is not at a constant level. The scan signal COM2 includes a plurality of scan pulses 60 respectively corresponding to the data pulses 40 of the data signals SEG1, SEG2, SEG3. In addition, when the light-source driving circuit 10 adjusts pulse width of the driving pulses 50 of the driving signals LEDR, LEDG, and LEDB for adjusting generation time of the adjusted-color backlight, the scan driving circuit 14 and the data driving circuit 12 respectively adjusts the pulse width of the scan pulses 60 of the scan signal COM2, and the pulse width of the data pulses 40 of the data signals SEG1, SEG2, SEG3 according to the generation time of the adjusted-color backlight.

In summary, an adjustment circuit for color sequential liquid crystal displays and an adjustment method thereof according to the present invention is provided. By control of the light-source driving circuit to generate a plurality of driving signals, the color sequential liquid crystal display generates a plurality of primary color backlights and at least one adjusted-color backlight according to the driving signals so as to adjust colors and brightness of the frames. Moreover, according to colors of the frames, the light-source driving circuit adjusts time of the color sequential LCD to generate the adjusted-color backlight so as to modify gray level of colors for increasing number of colors rendered.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An adjustment circuit for color sequential liquid crystal displays comprising:
a light-source driving circuit generating a plurality of driving signals and sends the driving signals to the color sequential liquid crystal display(LCD) for controlling the color sequential LCD to generate a plurality of primary-color backlights and at least one adjusted-color backlight while the adjusted-color backlight is generated behind one of the primary-color backlights; and
a display driving circuit for generating a display driving signal that is sent to the color sequential LCD;
wherein the color sequential LCD displays a frame according to the display driving signal, the primary-color backlights and the adjusted-color backlight and the light-source driving circuit adjusts time of the color sequential LCD to generate the adjusted-color backlight according to colors of the frame so as to adjust colors and brightness of the frame.

2. The device as claimed in claim 1, wherein the light-source driving circuit adjusts pulse width of a driving pulse of the driving signal corresponding to the adjusted-color backlight according to colors of the frame so as to adjust generation time of the adjusted-color backlight.

3. The device as claimed in claim 1, wherein display driving circuit comprising:
a data driving circuit generating a data signal and sending the data signal to the color sequential LCD; and
a scan driving circuit generating a scan signal and sending the scan signal to the color sequential LCD;
wherein the display driving signal includes the data signal and the scan signal.

4. The device as claimed in claim 3, wherein the scan signal includes a plurality of scan pulses and the data signal includes a plurality of data pulses while the scan pulses correspond to the data pulses.

5. The device as claimed in claim 4, wherein the scan driving circuit and the data driving circuit adjust pulse width of at least one scan pulse and pulse width of at least one data pulse corresponding to generation time of the adjusted-color backlight.

6. The device as claimed in claim 3, wherein the data signal includes a plurality of data pulses and the data driving circuit adjusts pulse width of at least one data pulse corresponding to generation time of the adjusted-color backlight.

7. The device as claimed in claim 1, wherein the adjustment circuit further comprising:
a timing control circuit generating a timing signal and sends the timing signal to the light-source driving circuit and the display driving circuit so that the light-source driving circuit and the display driving circuit respectively generate the driving signals and the display driving signal according to the timing signal.

8. The device as claimed in claim 1, wherein the color sequential liquid crystal display further comprising:
a backlight unit generating the primary-color backlights and the adjusted-color backlight according to the driving signals; and
a display module displaying the frame according to the display driving signal, the primary-color backlights and the mixing-color backlight.

9. The device as claimed in claim 1, wherein the primary-color backlights include a red backlight, a green backlight and a blue backlight.

10. The device as claimed in claim 1, wherein the adjusted-color backlight is a white backlight.

11. The device as claimed in claim 10, wherein the white backlight comprising a red backlight, a green backlight and a blue backlight.

12. An adjustment method for color sequential liquid crystal displays applied to a color sequential liquid crystal display(LCD) that receives a display driving signal comprising the steps of:
generating a plurality of driving signals and sending the driving signals to the color sequential LCD; the color sequential LCD generates a plurality of primary-color backlights and at least one adjusted-color backlight while the adjusted-color backlight is generated behind one of the primary-color backlights;
wherein the color sequential LCD displays a frame according to the display driving signal, the primary-color backlights and the adjusted-color backlight while time of the color sequential LCD to generate the adjusted-color backlight is adjusted according to colors of the frame so as to adjust colors and brightness of the frame.

13. The method as claimed in claim 12, wherein the step of adjusting time of the color sequential LCD to generate the adjusted-color backlight according to colors of the frame further comprising a step of:
adjusting pulse width of a driving pulse of the driving signal corresponding to the adjusted-color backlight according to colors of the frame so as to adjust generation time of the adjusted-color backlight.

14. The method as claimed in claim 12, wherein the display driving signal comprising a scan signal and a data signal.

15. The method as claimed in claim 14, wherein the scan signal includes a plurality of scan pulses and the data signal includes a plurality of data pulses while the scan pulses correspond to the data pulses.

16. The method as claimed in claim 15, wherein the method further comprising a step of:
adjusting pulse width of at least one scan pulse and pulse width of at least one data pulse corresponding to generation time of the adjusted-color backlight.

17. The method as claimed in claim 14, wherein the data signal includes a plurality of data pulses and pulse width of at least one data pulse is adjusted corresponding to generation time of the adjusted-color backlight

18. The method as claimed in claim 12, wherein before the step of generating a plurality of driving signals and sending the driving signals to the color sequential LCD, the method further comprising a step of:
generating a timing signal so as to generate the driving signals according to the timing signal.

19. The method as claimed in claim 12, wherein a backlight unit of the color sequential LCD generates the primary-color backlights and the adjusted-color backlight according to the driving signals and the display driving signal that is sent to a display module of the color sequential LCD so that the display module displays the frame according to the display driving signal, the primary-color backlights and the mixing-color backlight.

20. The method as claimed in claim 12, wherein the primary-color backlights include a red backlight, a green backlight and a blue backlight.

21. The method as claimed in claim 12, wherein the adjusted-color backlight is a white backlight.

22. The method as claimed in claim 20, wherein the white backlight comprising a red backlight, a green backlight and a blue backlight.
